(19) United States
(12) Patent Application Publication
(10) Pub. No.: US 2011/0303486 A1
(43) Pub. Date: Dec. 15, 2011

(54) Foldable Portable Vehicle Rack Ladder

(76) Inventor: Holly B. Halverson, Layton, UT (US)

(21) Appl. No.: 12/813,986

(22) Filed: Jun. 11, 2010

(51) Int. Cl. E06C 5/26

(52) U.S. Cl. 182/127

(57) ABSTRACT

A folding ladder and ladder support connection assembly comprising: an upper connection assembly; the upper connection assembly having a pair of upper connection members; each upper connection member comprising a first section with a strap that can encircle a roof rack support, roof rack, sport rack, luggage rack or similar surface. The first section transitions to the lower section which, due to the angle of the ladder in relation to the side of the vehicle, the rack to which the ladder is attached and the flexible straps or connections between the rungs or platforms which may consist of wood, plastic or other suitable material, that are secured equidistant on the straps or flexible connection members and comprise the steps of the ladder, will be angled away from the upper connection so that the rungs or platforms will be parallel to the ground upon which the vehicle is resting; constituting a flexible ladder system that can be easily connected and disconnected from a vehicle rack and can be used to load, skis, bicycles, other sporting goods; lumber pipes or other work supplies; or luggage that the user might want to secure to the vehicle rack.

### CROSS-REFERENCE TO RELATED APPLICATION

This application is the non-provisional application for U.S. Provisional Application No. 61/144,825.

### BACKGROUND OF THE INVENTION

Vehicle roof racks are often above the safe reach of a user who is loading or unloading the rack. Often these racks are designed to be loaded from the side of the vehicle where a permanent non-flexible ladder would be impractical. The present invention solves the limitations in the existing art by providing a folding flexible portable ladder system that can either temporarily or permanently be attached to a vehicle with a roof rack to assist the user in loading and unloading the rack.

### Brief Summary of the Invention

This invention is related to a collapsible or folding flexible portable ladder system that can be temporarily or permanently attached to a vehicle rack to assist the user in loading the rack. It addresses problems with existing art by its flexibility, portability and applicability to loading and unloading of vehicle roof racks.

### BRIEF DESCRIPTION OF THE FIGURES

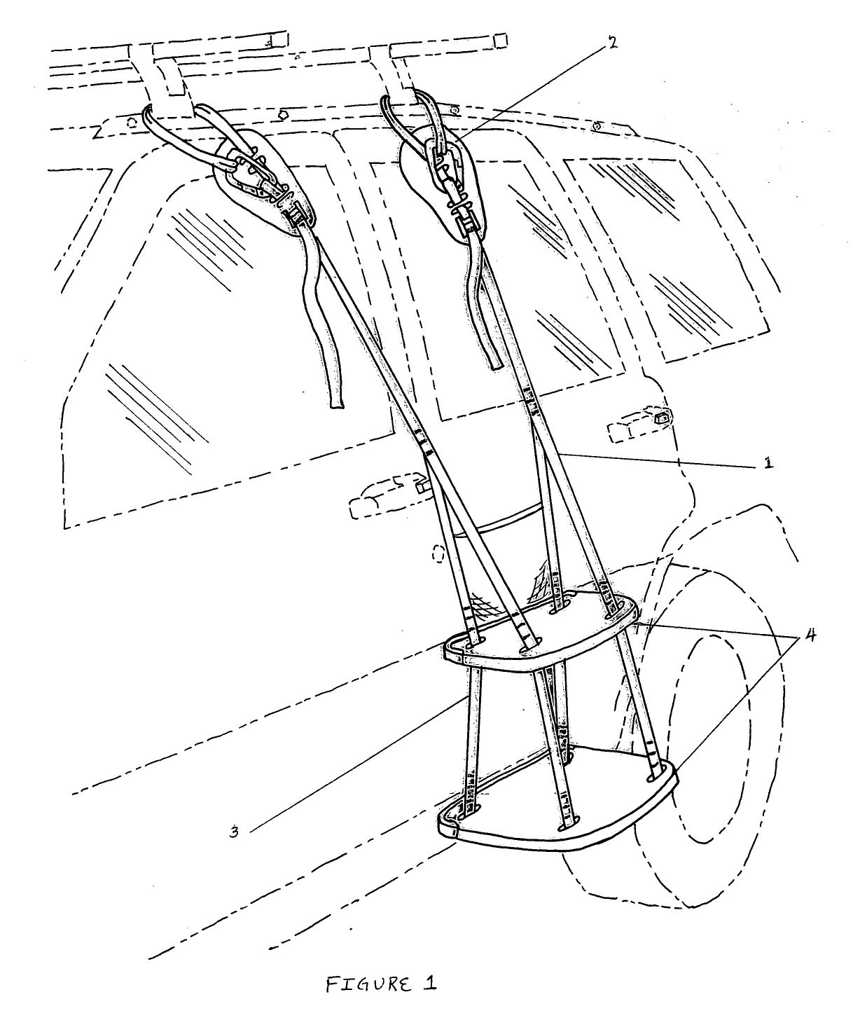

1) FIG. 1 is the front side view of the ladder system illustrating the flexible connecting members 1.1, the attachment mechanism for the roof rack 1.2, the lower flexible connection members between the rungs 1.3, and the rungs or platforms 1.4.

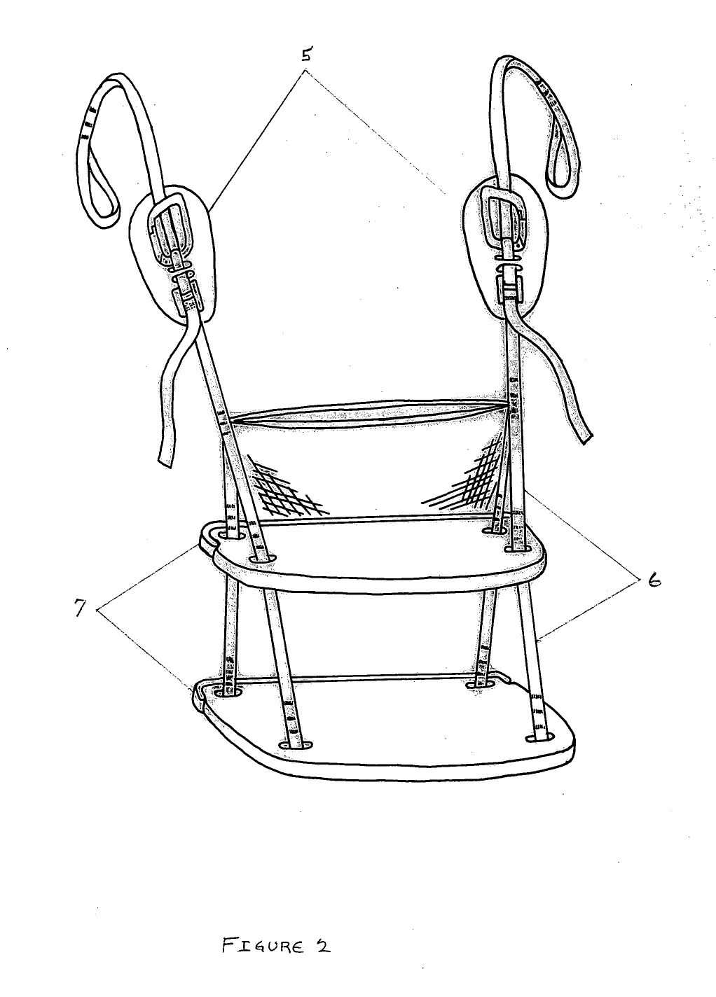

2) FIG. 2 is the front elevation view of the system showing the attachment mechanism 2.5, the adjustable flexible connection members 2.6, and the flexible bumpers 2.7.

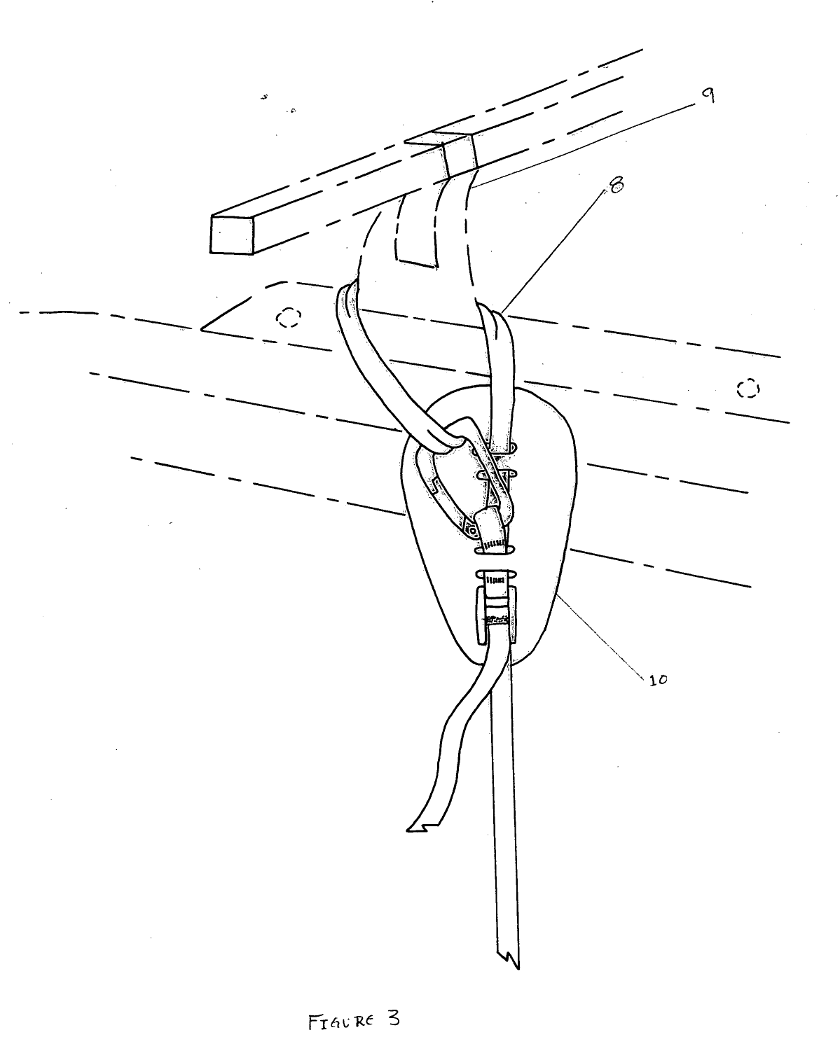

3) FIG. 3 is an exploded view of the attachment system showing the loop attachment mechanism 3.8, the roof attached rack and support 3.9, and the adjustment mechanism for the connection system 3.10.

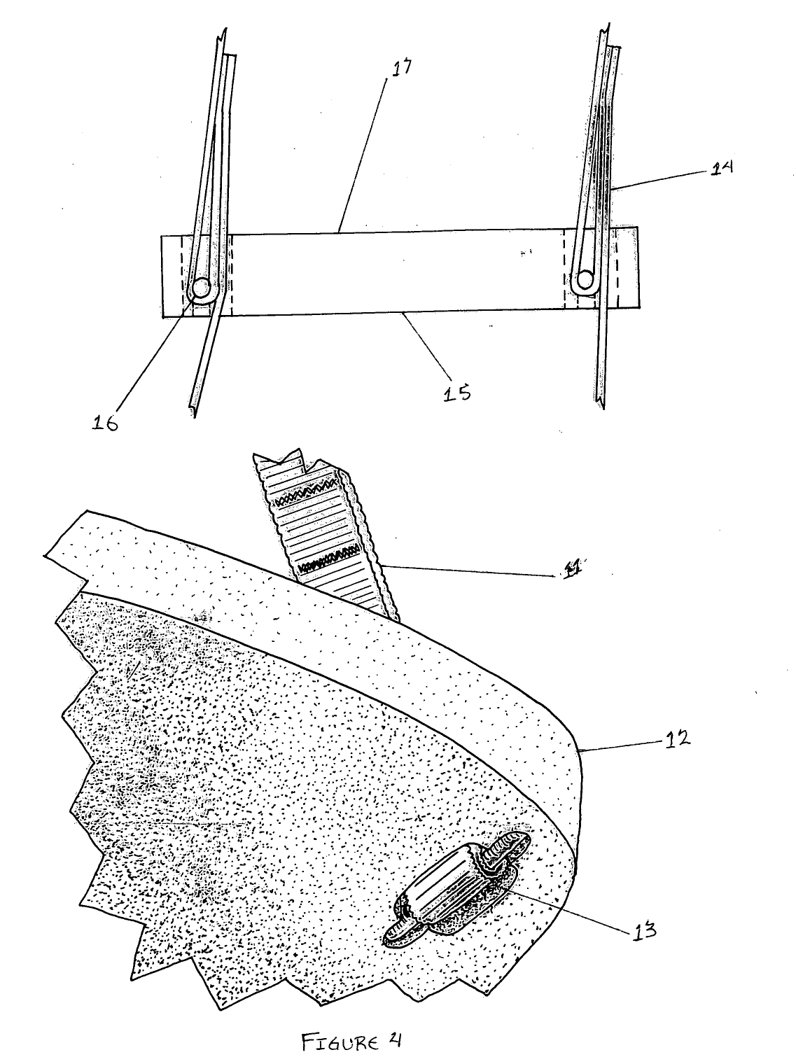

4) FIG. 4 is an exploded diagram of the strap connection mechanism 4.11, and the slip resistant platform or rung 4.12, with the attachment mechanism 4.13. The connection members 4.14 pass through a slot in the platform 4.15 and pass around the rods 4.16 that are inset in the platform. The platform is covered with a slip resistant material 4.17.

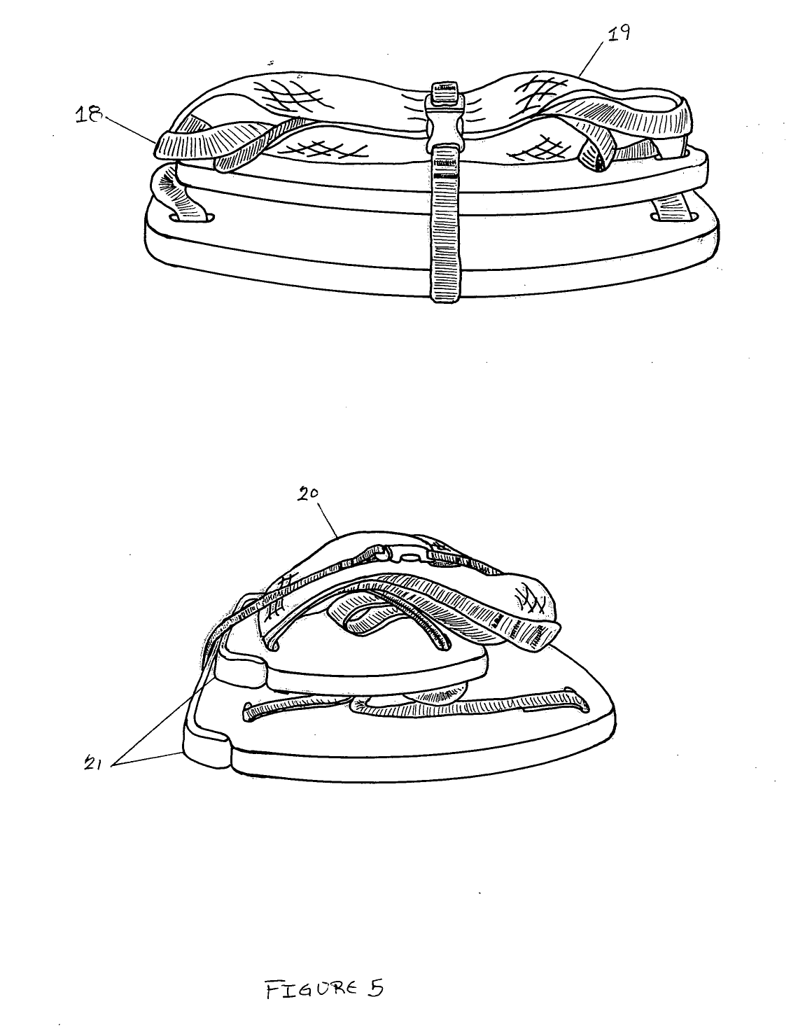

5) FIG. 5 depicts the system folded with the upper connection system, the flexible members and upper rungs 5.18 stored in an attached bag 5.19. The side view depicts the storage bag 5.20 and the flexible bumpers 5.21.

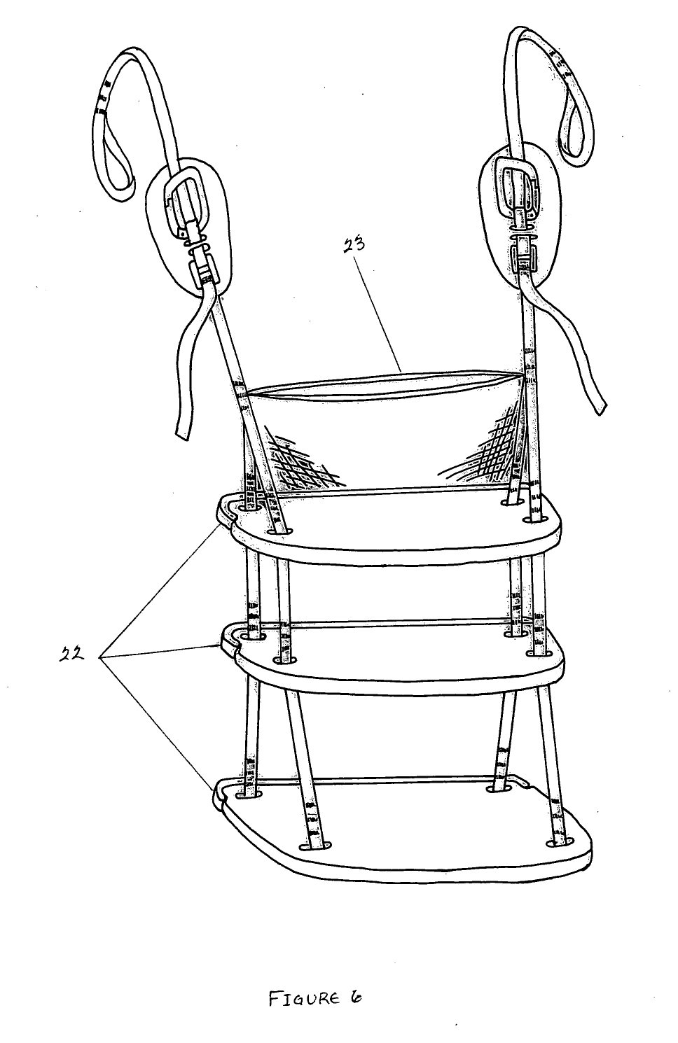

6) FIG. 6 depicts the multiple rungs or steps 6.22 and the attached storage bag 6.23.

### DETAILED DESCRIPTION OF THE INVENTION

This invention involves a folding ladder and ladder support connection assembly comprising: an upper connection assembly; the upper connection assembly having a pair of upper connection members; each upper connection member comprising a first section with a strap that can encircle a roof rack support, roof rack, sport rack, luggage rack or similar surface. The first section transitions to the lower section which, due to the angle of the ladder in relation to the side of the vehicle, the rack to which the ladder is attached and the flexible straps or connections between the rungs or platforms which may consist of wood, plastic or other suitable material, that are secured equidistant on the straps or flexible connection members and comprise the steps of the ladder, will be angled away from the upper connection so that the rungs or platforms will be parallel to the ground upon which the vehicle is resting; constituting a flexible ladder system that can be easily connected and disconnected from a vehicle rack and can be used to load, skis, bicycles, other sporting goods; lumber pipes or other work supplies; or luggage that the user might want to secure to the vehicle rack.

### PRIOR ART

Existing art with respect to vehicle ladder systems all describe permanently affixed non-flexible systems. U.S. Pat. No. 7,066,299 describes a permanently affixed receiver that is designed to receive a removable traditional ladder that can be temporarily affixed to the vehicle. The present invention is not a traditional ladder and does not require a permanently attached receiver. U.S. Pat. No. 7,066,299 achieves a vehicle offset through a horizontal fixed arm that rests upon the vehicle, while the instant invention conforms to the shape of the vehicle through its flexible connection members.

US Application 20040200197A1 describes a somewhat similar flexible ladder that attaches to the horn of a saddle. The instant invention differs in that it is designed to attach to a vehicle rack and includes slip free rungs to facilitate secure footing as the user ascends the ladder.

Other portable ladder systems are designed to assist the user to ascend tree, such as U.S. Pat. No. 5,806,626 and U.S. Pat. No. 5,727,648 but these ladders differ in that they are nonflexible ladders.

U.S. Pat. No. 5,064,023 achieve a laterally flexible ladder that can be permanently affixed to a vehicle. That invention is designed to allow fixed members to move in the event that they are struck, unlike the instant invention that allows both vertical and horizontal movement through flexible attached rungs.

1) A portable ladder system for loading sporting goods, tools or supplies and luggage on a rack secured to a vehicle comprising: a flexible ladder connection structure that can be temporarily or permanently secured to a vehicle rack or to a vehicle; flexible connection members where the top of the connection members is attached to the ladder connection structure, having one or more rungs, platforms or steps attached to the flexible supporting members thereby forming a flexible ladder.

2) The portable ladder of claim 1 wherein the portable ladder is of a length substantially equal to the distance between the attachment point on the rack and the ground or surface on which the vehicle is resting.

3) The portable ladder system of claim 1 wherein the connection structure may be comprised of straps, and metal or plastic buckles, cams or similar structures for securing the straps.

4) The portable ladder of claim 1 wherein the ladder is secured to a vehicle sports rack through slots, gendered connections integrated into the connection mechanism and the rack or other connecting mechanisms in the rack and/or in the rack supports that allow the ladder to be connected and disconnected from the slots.

5) The portable ladder of claim 1 wherein the ladder connection structure secures to a vehicle luggage rack that is adapted to receive a connecting structure from the ladder through slots, gendered connections integrated into the connection mechanism and the rack or other connecting mechanisms in the rack and/or in the rack supports that allow the rack to be detachably connected to the rack.

6) The portable ladder of claim 1 wherein the ladder connection structure secures to a vehicle work rack that is adapted to receive a connecting structure through slots, gendered connections integrated into the connection mechanism and the rack or other connecting mechanisms in the rack and/or in the rack supports that allow the ladder to be detachably connected to the rack.

7) The portable ladder of claim 1 wherein the flexible connection structures and the flexible connection members are comprised of straps or rope.

8) The portable ladder of claim 1 wherein the flexible connection structures and the flexible connection members are comprises of straps or rope composed of material consisting of nylon, polyester, polypropylene, Kevlar, cotton, hemp, sisal or similar materials.

9) The portable ladder of claim 1 wherein the flexible connection structures and the flexible connection members are comprised of braided straps or rope wherein each of the rungs are supported by alternating strands of the braided material.

10) The portable ladder of claim 1 wherein the flexible connection structures and the flexible connection members are comprised of metal chain or cable.

11) The portable ladder of claim 1 wherein at least one and up to one hundred rungs are attached and disposed between the flexible supporting members.

12) The portable ladder of claim 1 wherein the rungs are comprised of wood, metal, plastic or any combination thereof.

13) The portable ladder of claim 1 wherein the surface of each rung is covered with plastic, metal, fabric, sisal or other anti-slip material.

14) The portable ladder of claim 1 wherein the flexible connection structures, the flexible connection members and the rungs are designed to collapse into the largest rung so that the ladder can be secured and transported as a single flat unit.

15) The portable ladder of claim 1 wherein the flexible connection structures, the flexible connection members and the rungs are designed to collapse into an attached storage bag so that the ladder can be secured and transported as a single flat unit.

16) The portable ladder of claim 1 wherein the flexible connection structures, the flexible connection members and the rungs are designed to collapse so that they can be rolled and secured so that the ladder can be secured and transported as a single round unit.
